(19) United States
(12) Patent Application Publication
(10) Pub. No.: US 2009/0180187 A1
(43) Pub. Date: Jul. 16, 2009

(54) System and method for using diffractive elements for changing the optical pathway

(75) Inventors: Sharon Sade, Kfar-Yona (IL); Noam Sorek, Zikhron-Yaakov (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 12/285,290

(22) Filed: Oct. 1, 2008

Related U.S. Application Data
(63) Continuation-in-part of application No. 12/007,879, filed on Jan. 16, 2008.

(51) Int. Cl. G02B 27/44; G02B 27/42

(52) U.S. Cl. 359/573; 359/558

(57) ABSTRACT

An apparatus for adjusting an optical pathway, comprising a diffractive optics element configured for diffracting a plurality of light waves passing in the optical pathway, and a diffractive optics element (DOE) manipulator configured for manipulating said diffractive optics element, thereby changing the optical pathway.

### RELATIONSHIP TO EXISTING APPLICATIONS

This application is a continuation-in-part of U.S. patent application Ser. No. 12/007,879, filed on Jan. 16, 2008, the contents of which are hereby incorporated by reference.

### FIELD AND BACKGROUND OF THE INVENTION

The present invention, in some embodiments thereof, relates to optical imaging and, more particularly, but not exclusively, to a system for forming a multispectral image of an object. The present invention is applicable to, but not limited to, the imaging, focusing, and zooming functions in cameras, and more particularly, in cameras incorporated into cellular phones. Other applications include, but are not limited to, projecting images of objects, and adjusting the size and focus of the projected images.

In today's market, Image capturing devices are becoming more and more compact, and some are incorporated into thin devices, such as mobile phones, personal digital assistants (PDAs) and other hand-held devices, as well as laptop computers. Thus, the thickness of lenses which are used by such compact image capturing devices is respectively reduced.

The limited focal axis of such lenses limits the integration of a focus and/or optical zoom systems. As commonly known, an image is focused when light waves reflected from any one point of an object are reunited at one point of the image. If these light waves are not reunited at the image point, the image is out of focus. Most of today's mobile phone cameras achieve focus through fixed focus lenses where the focus of the lens is set during the manufacturing process. Usually, fixed focus lens cameras do not produce focused images of objects whose distance from the lens is less than 0.5 meter and do not allow changing the focus during the image capturing process.

Today's mobile phone camera modules are adjusted by digital zoom only, which is not optical zoom. As commonly known, digital zoom is a method of decreasing the apparent angle of view of a digital photographic or video image. Digital zoom is accomplished by cropping an image down to a centered area with the same aspect ratio as the original, and usually also interpolating the result back up to the pixel dimensions of the original. It is accomplished electronically, without any adjustment of the camera's optics, and no optical resolution is gained in the process. Because interpolation disturbs the original pixel layout of the image, as captured by the camera's image capturing sensor, it is usually considered detrimental to image quality. On the other hand, optical zoom has no adverse effect on image quality and is typically achieved by zoom lenses, which are assemblies of refractive elements, and have the ability to vary their focal lengths. Zoom lenses, however, require a certain size along their focal axis, that makes them unfit for mobile phone cameras. For example, U.S. Pat. No. 5,982,544 by Ogata discloses “a compact yet high-zoom-ratio lens system for use with lens shutter cameras”. However, the size of such system varies between 64 mm and 115 mm. Such a size is generally too large for mobile phone cameras. U.S. Pat. No. 7,304,804 discloses “a compact zoom lens device having a zoom lens system” the size of which along the focal axis is on the order of 55 mm, which is also generally too large for mobile phone cameras.

Refractive cameras with optical zoom designed incorporated in mobile phones are known to be characterized by a linear focal length of about 25-30 mm. Such a focal length requires an optical system with a respective thickness.

### SUMMARY OF THE INVENTION

According to some embodiments of the present invention there is provided an apparatus for adjusting an optical pathway. The apparatus comprises a diffractive optics element configured for diffracting a plurality of light waves passing in the optical pathway and a diffractive optics element (DOE) manipulator configured for manipulating the diffractive optics element, thereby changing the optical pathway.

Optionally, the plurality of light waves includes white light.

Optionally, the changing comprises changing the diffracting.

Optionally, the apparatus further comprises an image capturing sensor having a receiving side, the diffractive optics element being configured for diffracting the plurality of light waves to form an image on the receiving side.

More optionally, the apparatus further comprises a user interface configured for allowing a user to control the DOE manipulator thereby changing a magnification of the image.

More optionally, the apparatus is incorporated within a member selected from a group consisting of: a mobile phone, a personal digital assistant (PDA), a laptop, and a digital camera.

Optionally, the apparatus further comprises a refractive optical element, the optical pathway being manipulated according to the refractive optical element.

More optionally, the refractive optical element is a lens setup of a refractive image capturing device.

More optionally, the apparatus further comprises at least one refractive element for manipulating the plurality of light waves.

Optionally, the apparatus further comprises a correcting element on an image side of the diffractive optics element, for correcting aberrations caused by diffraction.

Optionally, the diffractive optics element comprises an odd number of diffractive sub-elements.

More optionally, the diffractive optics element comprises a first diffractive sub-element, a second diffractive sub-element, and a third diffractive sub-element.

More optionally, the first, second, and third diffractive sub-elements include diffractive gratings.

More optionally, the first diffractive sub-element transmits light waves of a first order of diffraction; the second diffractive sub-element transmits light waves of a second order of diffraction and the third diffractive sub-element transmits light waves of a third order of diffraction. The first order of diffraction is not less than the second order of diffraction, and the third order of diffraction is not less than the second order of diffraction.

More optionally, the first order of diffraction, the second order of diffraction, and the third order of diffraction are integer numbers in a range between 1 and 2.

More optionally, the second diffractive sub-element has alternating zones of at least two groove densities.

More optionally, the first diffractive sub-element has a first groove density; the second diffractive sub-element has alternating zones of different groove densities; and third diffractive sub-element has a third groove density. The first groove density is not less than the lowest of the different groove densities of the second diffractive sub-element and the third groove density is not less than the highest of the different groove densities of the second diffractive sub-elements.

More optionally, the DOE manipulator moves the second diffractive sub-element relative to the first diffractive sub-element, such that light transmitted by the first diffractive sub-element impinges the second diffractive sub-element in zones of a selected groove density, thereby creating a zoom effect.

More optionally, the DOE manipulator moves the second diffractive sub-element relative to the first diffractive sub-element in a direction normal to the focal axis.

More optionally, the second diffractive sub-element has alternating zones of two groove densities.

More optionally, the different groove densities comprise a higher groove density and a lower groove density. The first groove density is not less than the lower groove density, and the third groove density is not less than the higher groove density.

More optionally, the second diffractive sub-element has alternating zones of three different groove densities.

More optionally, the second diffractive sub-element has alternating zones of a plurality of groove densities.

More optionally, the zoom effect is gradually changing.

More optionally, the apparatus further comprises an image capturing sensor having a receiving side, the diffractive optics element being configured for diffracting the plurality of light waves to form an image on the receiving side, wherein a distance between the first diffractive sub-element and the image capturing sensor is less than 8 mm.

According to some embodiments of the present invention there is provided a method for adjusting an optical pathway. The method comprises using a diffractive optics element for diffracting a plurality of light waves reflected from an object in the optical pathway, manipulating the diffractive optics element, thereby adjusting the optical pathway, and forming an image of the object on a surface by diffractive means alone.

Optionally, the surface is a receiving surface of an image capturing sensor, placed close to the diffractive optics element.

Optionally, the method further comprises adjusting at least one property of the formed image by manipulating the diffractive optics element.

Optionally, the property is one of image size and image focus level.

Optionally, the method further comprises correcting for at least some optical aberrations of the image, by using at least one of: the diffractive optics element, the image capturing sensor, and a correcting element.

Optionally, the diffracting comprises: converging the light waves by a first diffractive element onto a second diffractive element, diverging the light waves by a second diffractive element onto a third diffractive element, and converging the light waves by a third diffractive element onto the surface.

Optionally, the manipulating comprises moving the second diffractive element, such that the light waves impinge the second diffractive element in zones of a specific groove density.

According to some embodiments of the present invention there is provided an optical device having a diffractive optics element, configured for diffracting light waves from an object and a surface upon which an image of the object is formed. The diffractive optics element forms the image upon the surface by diffractive means alone.

Optionally, the surface is a receiving surface an image capturing sensor, and the device is an image capturing device.

Optionally, the device further comprises at least one correcting element configured for correcting at least some optical aberrations of the image, caused by diffraction.

More optionally, the correcting element is a diffractive optics element.

Optionally, the device further comprises including a diffractive optics element (DOE) manipulator configured for manipulating the diffractive optics element. The manipulating of the diffractive optics element by the DOE manipulator causes a change in at least one property of the image.

More optionally, the property is one of focus level and zoom level.

More optionally, a length from an object side of the diffractive optics element to an object side of the surface is not more than 8 mm.

More optionally, the receiving the image capturing sensor is configured for reducing at least one optical aberration of the image caused by diffraction.

More optionally, at least one algorithm is programmed on an Image Signal Processor (ISP) chip connected to the image capturing sensor, the ISP chip reducing the at least one optical aberration according to the algorithm.

Optionally, the diffractive optics element is configured for reducing at least some optical aberrations of the image caused by diffraction.

Optionally, the light waves comprise white light.

More optionally, the device further comprises a user interface configured for allowing a user to control the DOE manipulator.

Optionally, the device is incorporated within a member selected from a group consisting of: a mobile phone, a personal digital assistant (PDA), a laptop, and a digital camera.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of some embodiments of the present invention, in which an image of an object is created on an image capturing sensor, by a diffractive optics element;

FIGS. 2A and 2B are schematic illustrations of some embodiments of the present invention, in which a property of the image is changed by manipulating the diffractive optics element;

FIG. 3 is a general schematic illustration of a mode of operation of some embodiments of the invention;

FIGS. 4A and 4B are schematic illustrations of some embodiments of the present invention, in which the diffractive optics element used for achieving zoom includes three diffractive sub-elements;

FIG. 5 is a schematic illustration of a diffractive sub-element characterized by zones of a plurality of groove densities, according to some embodiments of the present invention;

FIGS. 6A and 6B are schematic illustrations of some embodiments of the present invention, in which the focus of an image is changed;

FIGS. 7a and 7b are schematic drawings illustrating a hybrid refractive and/or diffractive image capturing device, according to some embodiments of the present invention; and

FIG. 8 is a flowchart of a method for changing image properties through diffraction.

### DESCRIPTION OF SPECIFIC EMBODIMENTS OF THE INVENTION

The present invention, in some embodiments thereof, relates to optical imaging and, more particularly, but not exclusively, to a system for forming a multispectral image of an object. The present invention is applicable to, but not limited to, the imaging, focusing, and zooming functions in cameras, and more particularly, in cameras incorporated into cellular phones. Other applications include, but are not limited to, projecting images of objects, and adjusting the size and focus of the projected images.

Some of the present embodiments of the invention relate to an image capturing device, which comprises one or more diffractive optics elements and an image capturing sensor. The diffractive optics element diffracts light leaving an object, and creates an image of the object on the image capturing sensor. Optionally, all the optical elements of the device are diffractive optics elements and all the optical functions which are performed by of the device are performed by the diffractive optics elements and the image capturing sensor, without any refractive optics elements. The image capturing sensor is herein also referred to as “image sensor” and “sensor”.

Optionally, the diffractive optics element corrects optical aberrations of the image, such as geometrical and chromatic aberrations.

Optionally, the image capturing device further includes a diffractive optics element (DOE) manipulator for changing the optical pathway of the light waves leaving the object by manipulating the diffractive optics element. The changing of the pathway affects one or more properties of the image which is formed by the diffractive optics element.

According to some embodiments of the invention, the diffractive optics element comprises an odd number of diffractive sub-elements, for example 3, 5, 9, or more sub-elements. Optionally, the sub-elements include diffraction gratings. According to some embodiments of the invention, the diffractive optics element includes three diffractive sub-elements: a frontal diffractive sub-element, a central diffractive sub-element, and a rear diffractive sub-element. Optionally, one or more of the diffractive sub-elements, for example the central diffractive sub-element, reduce at least some of the optical aberrations which are caused by diffraction. Optionally, the aforementioned DOE manipulator changes a position of at least one diffractive sub-element in relation to other diffractive sub-elements. In one embodiment of the present invention, a focusing effect is achieved by instructing the DOE manipulator to move one or more of the diffractive sub-elements, for example the central diffractive sub-element, along an optical axis of the diffractive optics element.

According to some of the present embodiments of the invention, an apparatus is provided for adjusting an optical pathway of light waves, by diffractive means, and optionally, by a combination of diffractive and refractive means. The apparatus comprises a diffractive optics element, and a diffractive optics element (DOE) manipulator, which acts on the diffractive optics element, in order to change the effect the diffractive optics element has on the optical pathway of the waves.

Optionally, the above apparatus includes at least one refractive optics element, for example a lens setup as found in a typical camera based on refractive optics. Optionally, the diffractive optics element is configured for changing at least one property of an imaged formed by the refractive optics element upon an image sensor. For example, the property is one of image size and image focus. Optionally, the above apparatus is part of a hybrid refractive/diffractive image capturing device.

According to some embodiments of the present invention, the diffractive optics element comprises an odd number of diffractive sub-elements. However, each diffractive sub-element reduces some amount of incoming light, so the use of too many diffractive sub-elements can be counterproductive.

According to some embodiments of the invention, the apparatus described above is used for changing a size of an image of an object. Optionally, such a change may lead to analogue zooming. Unlike refractive elements, diffractive elements do not need to move along the focal axis, in order to achieve zoom. Therefore, a typical diffractive zooming apparatus is smaller in size than a typical refractive zooming apparatus. Furthermore, a diffractive zooming apparatus may be made small enough to fit a cellular phone camera.

Depending on the size of the diffractive sub-elements, the diffractive sub-elements may be characterized by alternating zones of a plurality of groove densities. For a specific zooming range, for example between a zoom level of X:1 and (X+1):1, where X is a natural number, for example 1, 2, 5, 6.7, any intermediate number, a higher number, or a lower number, an apparatus which includes a low number of groove density zones, such as 2 or 3, where each groove density defines an intermediate zoom state, produces a discrete zoom. However, if a higher number of groove densities is fitted, where the groove densities optionally grow incrementally, a gradually changing zoom is achieved. Such a gradually changing zoom may be made to be characterized by smooth transitions between zoom states and may appear to a user to be continuous. More specifically, in order to achieve a smooth gradually changing zoom from X:1 to (X+1):1, where X is a natural number, six zones of incrementally growing groove densities are used. For example, for a gradually changing zoom ranging from 1:1 to 2:1, six zones are present on at least one of the diffractive sub-elements, where each zone is used for providing a zoom of 1:1, 1.2:1, 1.4:1, 1.6:1, 1.8:1, and 2:1, respectively. Optionally, more than six zones are used in order to achieve a smoother zoom. The number of zones is limited by the size of the diffractive sub-elements. Longer diffractive sub-elements can accommodate more zones of different groove densities.

According to some embodiments of the present invention, the diffractive optics element comprises three diffractive sub-elements, where one of the diffractive sub-elements, for example the central diffractive sub-element, is characterized by alternating sections of at least two groove densities. Optionally, the DOE manipulator is used to move the central diffractive sub-element, so all the light waves impinge the central diffractive sub-element in zones of a selected groove density. By changing the zones at which the central diffractive sub-element is impinged, the exit angle of the waves from the diffractive optics element is changed, as well as the size of the image, and therefore zoom is achieved.

According to some embodiments of the invention, the same diffractive optics element for adjusting optical pathways of light waves is used as part of a projector. More specifically, the diffractive optics element is used to adjust the size of an image projected onto a screen.

According to some embodiments of the present invention, a method is provided for zooming by diffractive means. A method is also provided for adjusting the size of projected images, using diffractive means.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

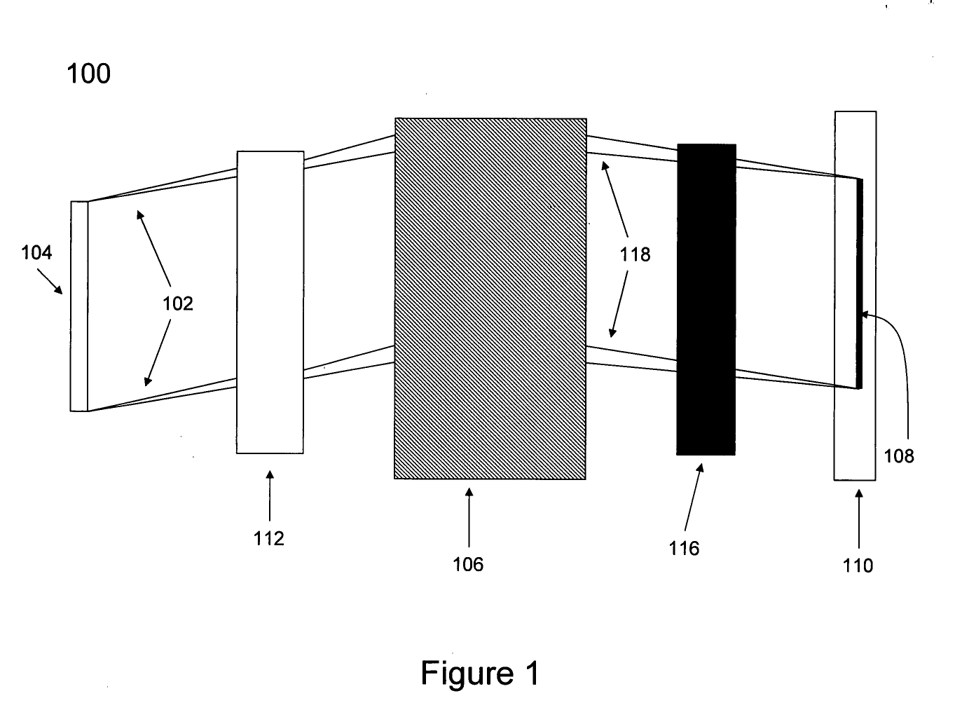

Reference is now made to FIG. 1 which is a schematic illustration of an apparatus 100 which is defined according to some embodiments of the present invention. Apparatus 100 includes a diffractive optics element 106 for adjusting the optical path of light waves 102 originating and/or reflected from an a scene and/or an object 104, and a sensor 110. Optionally, apparatus 100 further comprises a refractive optics element 112 for further adjusting and controlling the optical path of light waves 102, and a correcting element 116, for correcting optical aberrations, such as geometrical and/or chromatic aberrations which may be formed on image 108.

Apparatus 100 creates an image 108 of object 104 on a surface of sensor 110. In some embodiments of the invention, image 108 is created solely by diffractive optics element 106, without any assistance by any other optical elements. According to such embodiments, refractive optics element 112 is not present within apparatus 100, and correcting element 116 is not a refractive element. Optionally, correcting element 116 is a diffractive element. Optionally, diffractive optics element 106 also corrects for at least some of the optical (geometrical and chromatic) aberrations of image 108. Optionally, sensor 110 is designed to correct at least some of the optical aberrations of image 108.

Optionally, refractive optical element 112 is placed on an object side of diffractive optical element 106, to further adjust the optical pathway of light waves 102. Optionally, apparatus 100 includes a correcting element 116, to correct any chromatic aberration that is caused by diffraction of light waves 102 by diffractive optics element 106. Optionally, correcting element 116 is incorporated within diffractive optics element 106. Optionally, correcting element 116 is incorporated within sensor 110.

Because of the diffraction, light waves 118 that exit from diffractive optics element 106 may have a decreased intensity in relation to the intensity of the light that is reflected from and/or emitted by object 104. Depending on the type and properties of diffractive optics element 106, the energy loss can be quite substantial, and image 108 can be quite dim. Therefore, sensor 110 receives light waves 118, which may be characterized by an energy lower than an energy of light waves 102. The lower energy of light waves 118 may reduce the quality of image 108. Optionally, sensor 110 is configured to enhance image 108 created by light waves 118, before image 108 reaches the eyes of a user. Optionally, sensor 110 is configured for transferring image 108 onto a display. The image on the display reaches the eyes of a user. Because of energy losses caused by diffraction, image 108, and therefore the image on the display, may be dimmer than object 104 is to the user. Optionally, before transferring the image onto the display, sensor 110 enhances image 108, so that light waves leaving the display and reaching a user have an intensity which is closer to the intensity of light waves 102 leaving object or scene 104. Optionally, sensor 110 enhances image 108 optically, through diffractive correcting element 116 comprised within sensor 110. Optionally, sensor 110 enhances image 108, by changing one or more of the image properties through one or more algorithm programmed into sensor 110. Optionally, one or more algorithms are programmed onto an Image Signal Processor (ISP) chip connected to sensor 110, as is common in the art. Optionally, the ISP chip also corrects for at least some of the optical aberrations caused by diffraction.

Optionally, sensor 110 includes a charge coupled device (CCD) and/or 3CCD sensor. Optionally, sensor 110 includes a complementary metal oxide semiconductor (CMOS) sensor.

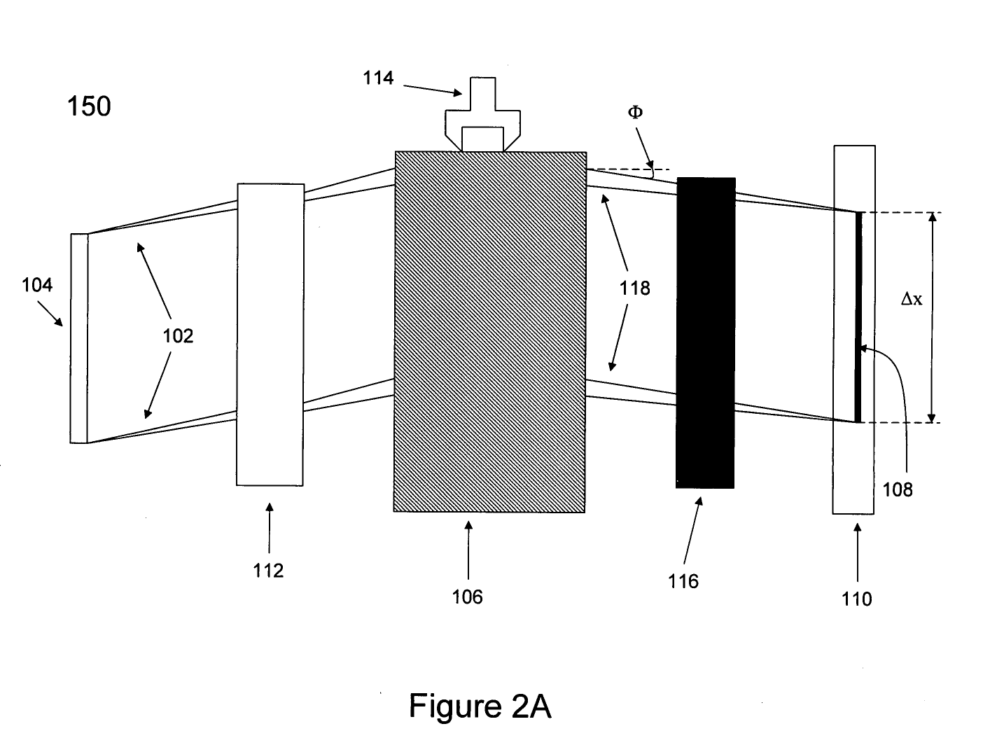

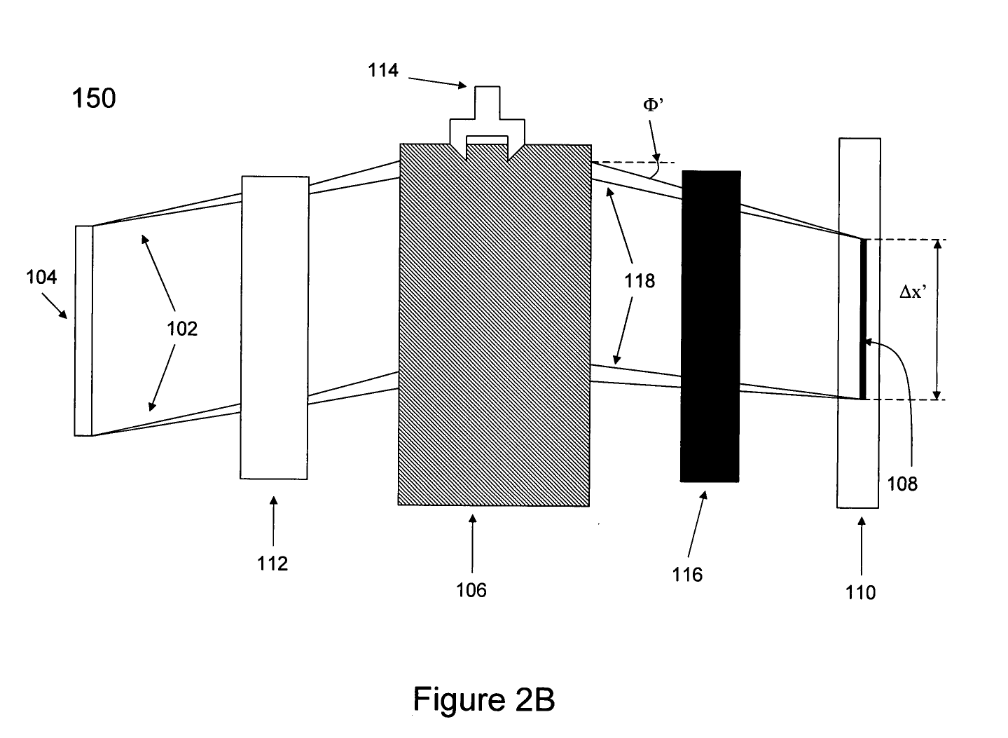

Reference is now made to FIGS. 2A and 2B, which are schematic illustrations of some embodiments of the present invention.

Apparatus 150 includes all the elements depicted in apparatus 100 described in FIG. 1. In addition, apparatus 150 further includes a diffractive optics element (DOE) manipulator 114 for adjusting the pathway of the light waves 102 by manipulating the diffractive optics element 106 and/or the positioning of sub-elements thereof.

FIGS. 2A and 2B depict an apparatus 150 for adjusting an optical pathway of light waves 102 which are reflected and/or emitted from object 104 and impinge sensor 110, such as an image sensor, optionally as described above. The adjustment is achieved by manipulating diffractive optics element 106. According to such an embodiment, apparatus 150 may change at least one property of an image 108 of the object 104 that is formed on the receiving side of the sensor 110 by adjusting the optical pathway of light waves 102 which are emitted by and/or reflected from object 104. In the embodiment shown in FIGS. 2A and 2B, a size of the image may be changed by manipulating the diffractive optics element 106. Optionally the property that is changed is the focus of the image.

In FIG. 2A, DOE manipulator 114 manipulates diffractive optics element 106 so that light waves 118 exit diffractive element 106 at diffraction angles Φ, thereby creating image 108 of size Δx on sensor 110. In FIG. 2B, DOE manipulator 114 acts on diffractive element 106 differently, so that the size of diffraction angles is changed to Φ′, and the size of the image is changed to Δx′.

Optionally, as described above, apparatus 150 has a limited thickness, optionally around 8 mm. Such a limited thickness allows the integration of the apparatus into relatively thin mobile phone, optionally as a mobile phone camera. In such an embodiment, the DOE manipulator may be controlled by the user interface of the mobile phone, optionally the keypad. Furthermore, as commonly known, optical design of a high performance compact digital imaging devices is done under many constraints such as size and the required optical characteristics of the optical unit. These constraints sometimes contradict to the required optical characteristics of the optical design. Moreover, in order to design small sized optics, one needs to bend light rays at sharp angles. In light of such constraints, the aforementioned optical designer is required to make even more efforts in order to finalize the optical design of the optical elements. The effect of such constraints may even be more pronounced when wide field of view (WFOV) lenses are used. Using apparatus 150 instead of an image capturing device that uses a set of zoom lenses may facilitate the optical design of a high performance compact digital imaging device. Apparatus 150 uses DOE manipulator 114 for manipulating diffractive optics element 106, and thereby achieves a zoom effect without zoom lenses or any other refractive zoom system, optionally as outlined above and described below.

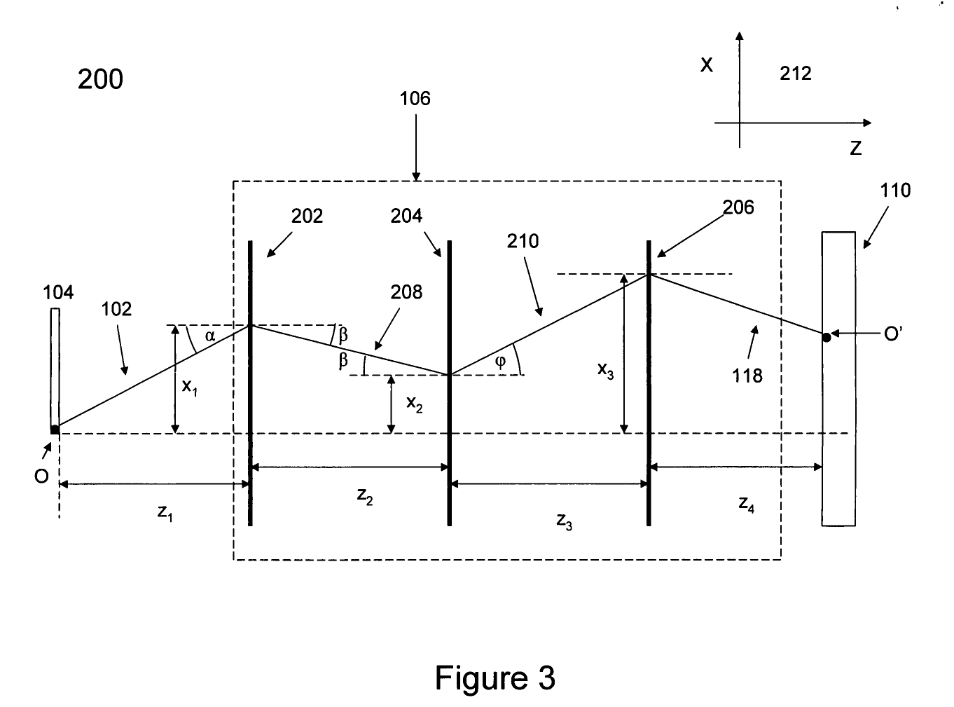

FIG. 3 is a general schematic illustrating a mode of operation of some embodiments of the invention. In apparatus 200, the optical path of a single light wave 102 originating from a point O on an object 104 is tracked from its emission to its encounter with a sensor 110, with respect to a coordinate system 212, where z is the focal axis, and x is normal to it.

FIG. 3 shares the same basic elements as FIG. 1, except for a refractive optics element and a correcting element. In FIG. 3, diffractive optics element 106 includes, from an object side to an image side thereof, a frontal diffractive sub-element 202, a central diffractive sub-element 204, and a rear diffractive element 206, which optionally are diffraction gratings. Frontal diffractive sub-element 202 may be referred to as first diffractive sub-element; central diffractive sub-element 204 may be referred to as second diffractive sub-element; rear diffractive sub-element 206 may be referred to as third diffractive sub-element.

After being emitted or reflected from object 104, light wave 102 encounters frontal diffractive sub-element 202. Frontal diffractive sub-element 202 has a distance z₁ from object 104, transmits waves of order n₁, and is characterized by groove density v₁. The height in the x-direction, with respect to point O, at which the encounter takes place, is x₁.

Light wave 208 is transmitted and reaches central diffractive sub-element 204, at height x₂. Central diffractive sub-element 204 has a distance z₂ from frontal diffractive sub-element 202, transmits waves of order n₂, and is characterized by groove density v₂.

Light wave 210 is transmitted, and reaches a rear diffractive sub-element 206, at height x₃. Rear diffractive sub-element 206 has a distance z₃ from second diffractive sub-element 204, transmits waves of order n₃, and is characterized by groove density v₃. Light wave 118 is transmitted, and reaches sensor 110 at O′. Sensor 110 has a distance z₄ from rear diffractive element 206.

For diffractive sub-elements, the equation describing the diffraction angles is

sin θᵢ+sin θ_{d}=nλv [1]

where θᵢ denotes the angle of incidence and θ_{d} denotes the angle of diffraction. v is the line density of a diffractive sub-element, λ denotes the wavelength of the light wave impinging the diffractive sub-element, and n denotes the order of diffraction of the transmitted wave.

For frontal diffractive sub-element 202, α denotes the angle of incidence, and β denotes the angle of diffraction. Equation [1] can be expressed in terms of coordinate system 212, as:

$$\frac{{x}_{1}}{\sqrt{{x}_{1}^{2} + {z}_{1}^{2}}} + \frac{{x}_{1} - {x}_{2}}{\sqrt{{( {x}_{1} - {x}_{2} )}^{2} + {z}_{2}^{2}}} = {n}_{1} λ {v}_{1} \qquad [ 2 ]$$

For central diffractive sub-element 204, the angle of incidence is β, and the angle of diffraction is φ. Equation [1] can be rewritten as:

$$\frac{{x}_{1}}{\sqrt{{x}_{1}^{2} + {z}_{1}^{2}}} + sin ϕ = {n}_{2} λ {v}_{2} \qquad [ 3 ]$$

Combining equations [2] and [3], and solving for φ, yields:

$$sin ϕ = arcsin [ ( {n}_{2} {v}_{2} - {n}_{1} {v}_{1} ) λ + \frac{{x}_{1}}{\sqrt{{x}_{1}^{2} + {z}_{1}^{2}}} ] \qquad [ 4 ]$$

Equation [4] shows that the exit rays from central diffractive sub-element 204 are divergent. Therefore rear diffractive sub-element 206 is necessary to re-converge the waves to form an image on sensor 108.

Though equation [4] has many possible solutions, an exemplary solution involves values such that n₁≧n₂, n₃≧n₂, v₁≧v₂, and v₃≧v₂. In addition, according an exemplary configuration of the invention, diffractive sub-elements 202, 204, and 206 are optionally configured to transmit light waves of low diffractive orders, such as first, second, and third diffractive orders. Optionally, these diffractive orders are limited to first order of diffraction and/or second order of diffraction. This is because lower order diffracted light waves are generally more energetic than higher order diffracted light waves. Such a configuration may help reduce the energy losses caused by diffraction.

Equation [4] teaches that varying the order of diffraction n and keeping the groove density v constant among diffractive sub-elements is equivalent to keeping n constant and varying v. Optionally, according to an exemplary embodiment of the invention, diffractive sub-elements 202, 204, and 206 transmit light waves of first diffractive order, and the groove densities of diffractive sub-elements 202, 204, and 206 are chosen to differ from each other.

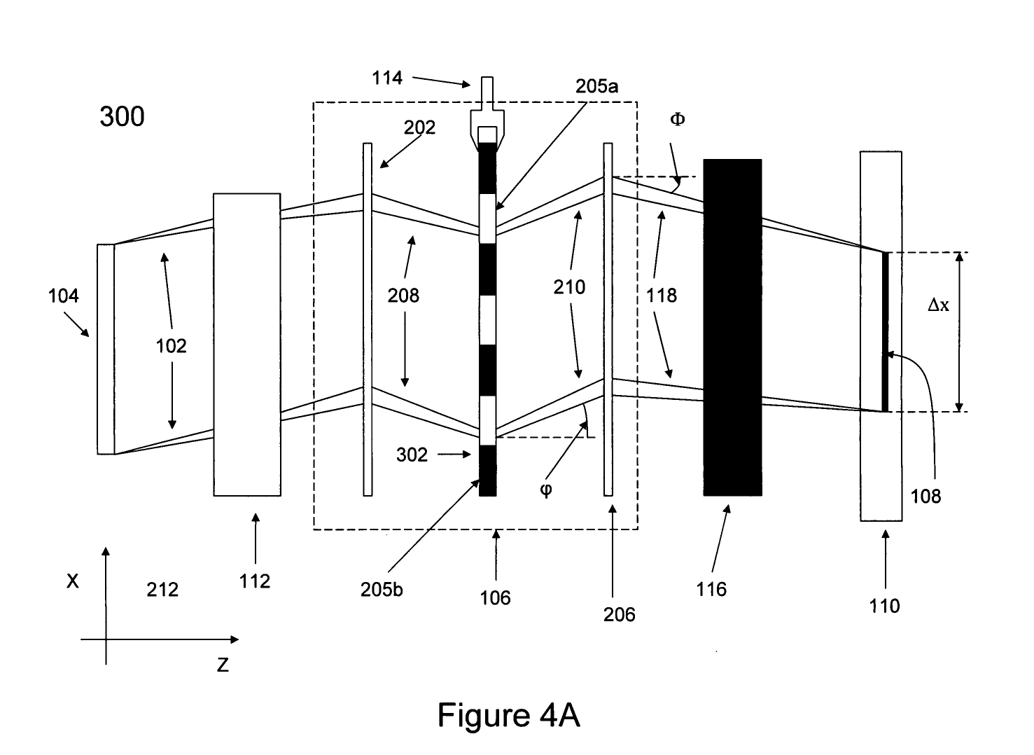

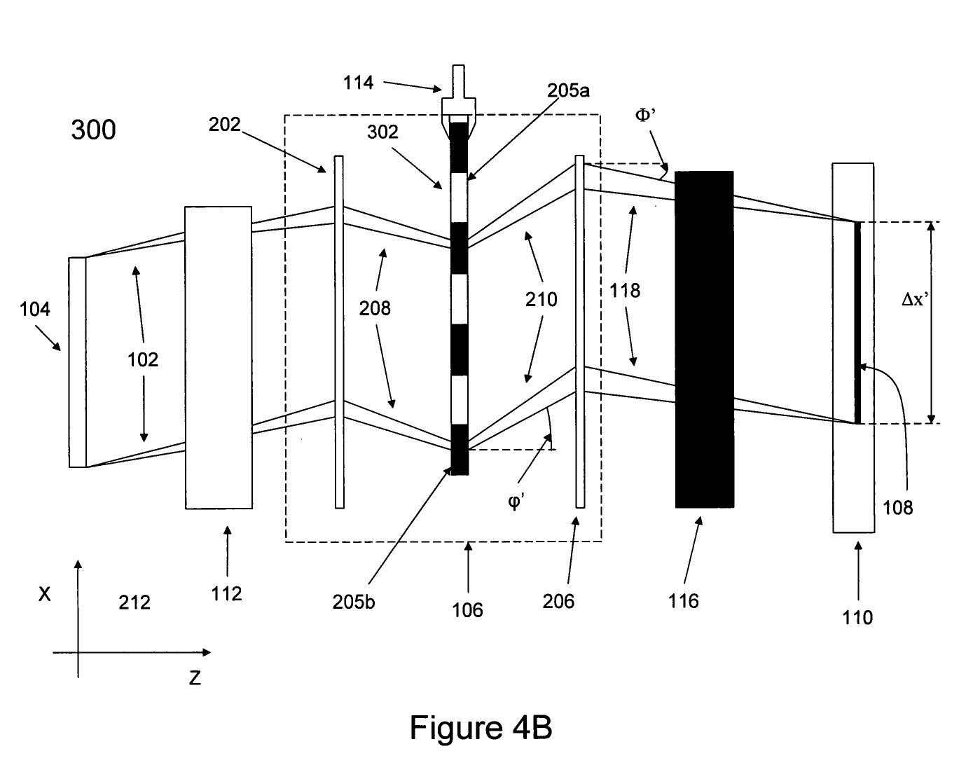

FIGS. 4A and 4B are schematic illustrations of some embodiments of the present invention, in which zoom is achieved by a diffractive optics element, which includes three diffractive sub-elements. According to this embodiment, an apparatus 300 is provided to change a size of an image 108 of an object 104, by adjusting an optical pathway of light waves 102 emitted and/or reflected by object 104.

FIGS. 4A and 4B depict apparatus 300 that comprises the same elements as apparatus 150 shown in FIGS. 2A and 2B. However, FIGS. 4A and 4B further comprise a diffractive optics element 106 that comprises a number of sub-elements. According to the exemplary embodiment shown in FIGS. 4A and 4B, diffractive optics element 106 comprises, from an object side to an image side thereof, a frontal diffractive sub-element 202, a central diffractive sub-element 302, and a rear diffractive sub-element 206. Central diffractive sub-element 302 has alternating zones 205a and 205b, characterized by a first groove density and a second groove density, respectively. Optionally, DOE manipulator 114 moves central diffractive sub-element 302 in a direction normal to the optical axis.

In FIG. 4A, light waves 102 are diffracted by frontal diffractive sub-element 202. Light waves 208, transmitted by frontal diffractive sub-element 202, are converged toward a surface of central diffractive sub-element 302, so that light waves 208 encounter only zones 205a characterized by a first groove density. Light waves 210 are diffracted and transmitted by central diffractive sub-element 302 at an angle of diffraction φ. Light waves 210 diverge and impinge rear diffractive sub-element 206, which transmit converging light waves 118 at an angle of diffraction Φ. Finally, image 108 of size Δx is formed on sensor 110.

In FIG. 4B, DOE manipulator 114 moves central diffractive sub-element 302, so that light waves 208 impinge zones 205b, characterized by a second groove density. Consequently, light waves 210 leave second diffractive element 302 at a different diffraction angle φ′, and light waves 118 leave rear diffractive sub-element 206 at a different diffraction angle Φ′. The size of image 108, is therefore changed to Δx′. Optionally, central diffractive sub-element 302 has a length of 3 mm in the x-direction, and zones 205a and 205b have lengths of 100 μm, in the x-direction. Optionally, DOE manipulator 114 moves central diffractive sub-element 302 by 100 μm, in the x-direction.

Optionally central diffractive sub-element 302 and rear diffractive sub-element 206 are opposing surfaces of a single slab, and the whole slab is moved by DOE manipulator 114. Optionally frontal diffractive sub-element 202, central diffractive sub-element 302, and rear diffractive sub-element 206 include diffraction gratings. For example, the diffractive sub-elements may include one, more, or a combination of holographic transmission gratings having linear grooves, holographic transmission gratings having circular grooves, blazed gratings, kinoform gratings, and sinusoidal gratings.

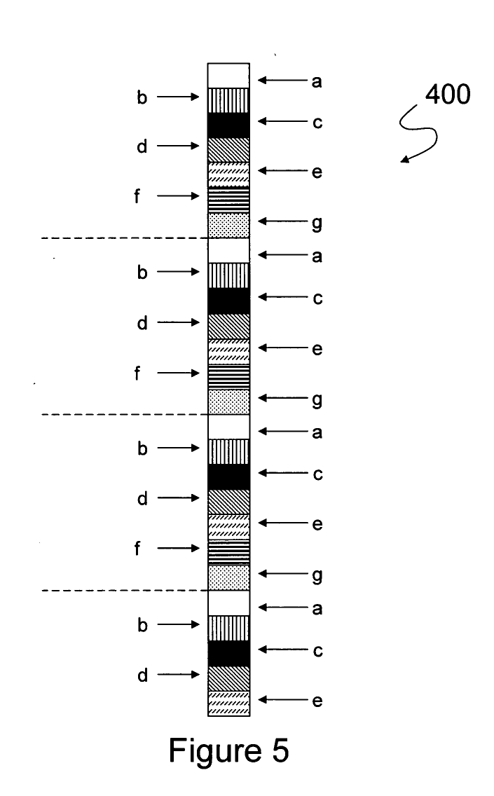

As depicted in FIGS. 4A and 4B, central diffractive sub-element 302 has zones of two different groove densities, therefore image 108 can have two different sizes and discrete zoom is achieved. Optionally, central diffractive sub-element 302 contains zones of more than two different groove densities, and the size of image 108 can be changed more than once, but still discretely. Optionally, central diffractive sub-element 302 has a plurality of zones, each characterized by a groove density, such that the groove densities optionally incrementally increase from one zone to the next, as shown in FIG. 5, described below. The plurality of zones optionally repeats itself along the surface of central diffractive sub-element 302. In such a setting, a gradually changing zoom is achieved.

According to an exemplary configuration of the invention, refractive element 112 is not present, central diffractive element 302 has zones of a first groove density v₂′ of about 200 g/mm, and second groove density v₂″ of about 400 g/mm, where g/mm is read as “grooves per millimeter”. The diffractive sub-elements have an effective area of about 3 mm×3 mm. Zones 205a and 205b of different groove density have lengths of about 100 μm. In this exemplary configuration, a discrete zoom of 2:1 is achieved, for the following values:
n₁=2;
n₂=1;
n₃=2;
v₁=about 200 g/mm;
v₃=about 400 g/mm;
z₂=about 2.5-about 3.5 mm;
z₃=about 1.5-about 2.5 mm; and
z₄=about 2 mm.

If central diffractive element 302 has zones of a first groove density v₂′=about 200 g/mm, second groove density v₂″=about 400 g/mm, and a third groove density v₂′″=about 1000 g/mm, discrete zooms of 2:1 and 5:1 are achieved, for the following exemplary values:
n₁=2;
n₂=1;
n₃=2;
v₁=about 200 g/mm;
v₃=about 1000 g/mm;
z2=about 2.5-about 3.5 mm;
z3=about 1.5-about 2.5 mm; and
z4=about 2 mm.

The values of the groove densities depend on the desired magnifications, and are chosen according to the desired magnifications. In general, each zone measures about 100-200 μm, so if the size of the central diffractive sub-element 302 is about 1-3 mm, central diffractive sub-element 302 may contain 5-15 different zones.

As shown by the above examples, optical zoom is achieved, by using a diffractive apparatus measuring about 6-8 mm along its focal axis. This apparatus is has a relatively limited in thickness, if compared typical compact refractive apparatuses described earlier in the background section, measuring 55 to 115 mm. Furthermore, because of their limited thickness, the above exemplary diffractive zooming apparatuses are easily fitted into mobile phone cameras.

Optionally, diffractive optics element 106 includes any odd number of diffractive sub-elements. Optionally, diffractive optics element 106 includes five or seven diffractive sub-elements. Optionally, one, some, or all diffractive sub-elements are characterized by zones of different groove densities. DOE manipulator 114 optionally manipulates one, some, or all optical sub-elements. A diffractive optics element comprising five or seven sub-elements, of which more than one is characterized by zones of different groove densities, provides a user with a larger selection of zoom ratios. Therefore, more diffractive sub-elements provide better control of the zooming capability of the apparatus as well as more zooming options. However, each diffractive sub-element causes an energy loss of about 10%-20% to light waves 102.

FIG. 5 is a schematic illustration of a diffractive sub-element characterized by zones of a plurality of groove densities, according to some embodiments of the present invention. Diffractive sub-element 400 has a plurality of zones, each characterized by a groove density. The plurality of zones repeats itself along the surface of diffractive sub-element 400.

Zones designated by the same letter have the same groove density. For example, in FIG. 5, all zones designated by the letter “a” have the same groove density, all zones designated by the letter “b” have the same groove density, and so on. Optionally, the groove densities incrementally increase from one zone to the next.

The characteristics of diffractive sub-element 400, make diffractive sub-element 400 configured for changing the optical pathway of a light waves in a gradually changing manner. Optionally, diffractive sub-element 400 may be substituted to central diffractive sub-element 302 as shown in FIGS. 3a and 3b, in order to achieve a gradually changing zoom.

According to some embodiments of the present invention, a central diffractive element with N zones of different groove densities, v₂⁽¹⁾, v₂⁽²⁾, v₂⁽³⁾, v₂⁽ⁱ⁾, . . . , v₂^{(N-1)}, v₂^{(N)}, is optionally set up so that v₁≧v₂⁽¹⁾, v₂⁽²⁾>v₂⁽¹⁾, v₂⁽³⁾>v₂⁽²⁾, . . . , v₂⁽ⁱ⁺¹⁾>v₂⁽ⁱ⁾, . . . , v₂^{(N)}>v₂^{(N-1)}, and v₃≧v₂^{(N)}, where i is an integer, such that 1≦i<N. For a given zoom range, a higher value of N creates a smoother transition between zoom states. As N grows, the transition between zoom states becomes less and less noticeable, until the zoom becomes a gradually changing zoom that appears to a user to be continuous.

According to an exemplary, non-limiting, embodiment of the invention, diffractive sub-element 400 has groove densities ranging from about 200 g/mm to about 400 g/mm, and increasing in increments of 40 about g/mm from zone to zone. Six zones are present, and each zone has a length of about 20 μm. Exemplary diffractive sub-element 400 is used instead of central diffractive sub-element 302 described in FIGS. 4A and 4B. Using only diffractive means, a gradually changing zoom between 1:1 and 2:1 is achieved for exemplary values:
n₁=2;
n₂=1;
n₃=2;
v₁=about 200 g/mm;
v₃=about 400 g/mm;
z₂=about 2.5-about 3.5 mm;
z₃=about 1.5-about 2.5 mm; and
z₄=about 2 mm.

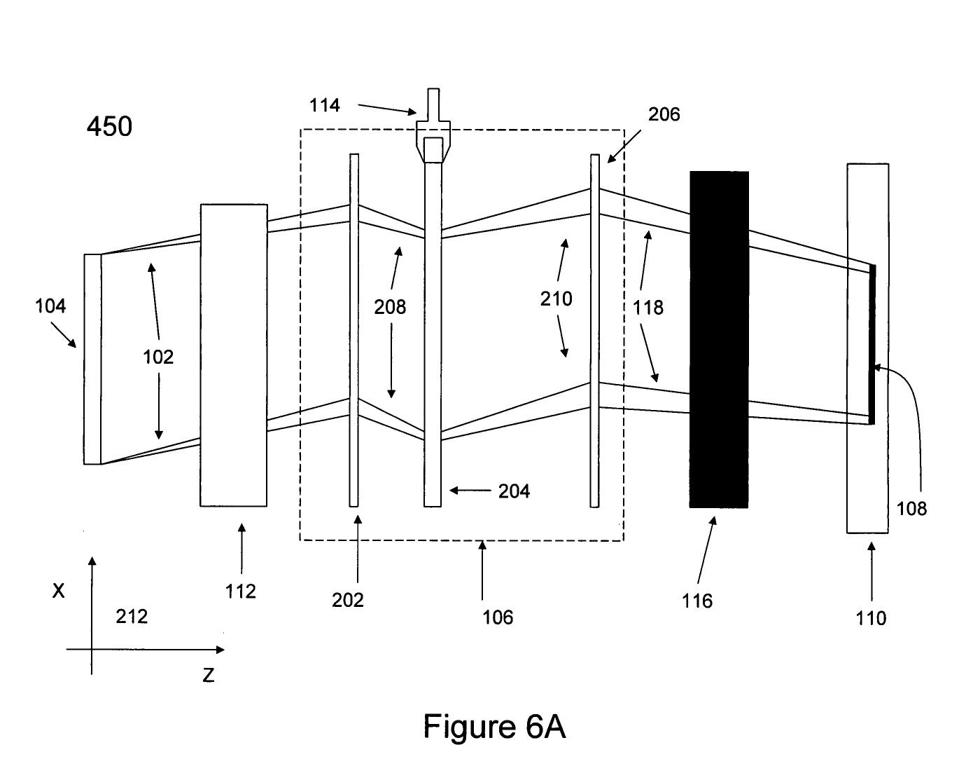

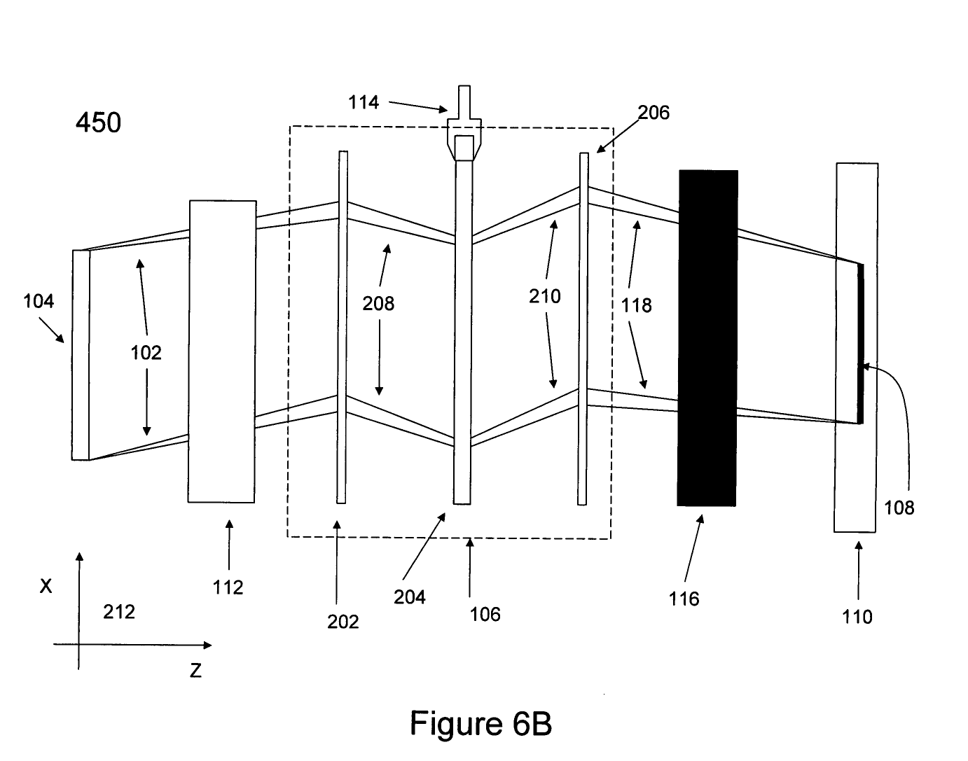

FIGS. 6A and 6B are schematic illustrations of some embodiments of the present invention, in which a focus of the image is changed by a diffractive optics element, which includes three diffractive sub-elements. According to these embodiments, an apparatus 450 is provided to change a focus of image 108 of an object 104, by adjusting the optical pathway of light waves 102 emitted and/or reflected by object 104.

FIGS. 6A and 6B depict an apparatus 450 that comprises the same elements as apparatus 300 shown in FIGS. 4A and 4B. Instead of central diffractive sub-element 302 characterized by zones of different groove densities, apparatus 450 includes a central diffractive sub-element 204, which is characterized by uniform groove density. Optionally, central diffractive sub-element 204 is characterized by a non uniform groove density. Optionally, any of the diffracting sub-elements correct for at least some to of the chromatic and/or geometrical aberrations caused by diffraction. Optionally, only central diffractive sub-element 204 corrects for at least some of the chromatic and/or geometrical aberrations caused by diffraction.

In FIG. 6A, light waves 102 are diffracted by frontal diffractive sub-element 202. Light waves 208, transmitted by frontal diffractive sub-element 202, are converged toward a surface of central diffractive sub-element 204. Light waves 210 are diffracted and transmitted by central diffractive sub-element 204. Light waves 210 diverge and impinge rear diffractive sub-element 206, which transmits converging light waves 118. Then, image 108 is formed on sensor 110. As light waves leaving object 104 are not reconnected at the surface of sensor 110, the image 108 may not be focused.

In FIG. 6B, image 108 is focused. DOE manipulator 114 moves central diffractive sub-element 204 along the focal axis. The repositioning of central diffractive sub-element 204 changes the location at which light waves 208 impinge central diffractive element 204 and the location at which light waves 210 impinge rear diffractive element 206, thereby allowing light waves 118 to reconnect on the surface of sensor 110 and to create a focused image 108.

Optionally, apparatus 450 measures about 5-10 mm along its focal axis, and a noticeable change of focus is achieved by moving central diffractive sub-element 204 by about 0.5 mm along the focal axis (along the Z axis, as defined by coordinate system 212). Therefore, a diffractive camera using apparatus 450 may be thin enough along the camera's focal axis to fit thin devices, such as such as mobile phones, laptop computers, and PDAs.

Optionally, a focus of image 108 is changed by moving any one, some, or all of the diffractive sub-elements with respect to the other diffractive sub-elements and/or to sensor 110. Optionally, the focus of image 108 is changed by moving the whole diffractive optics element 106, with respect to sensor 110.

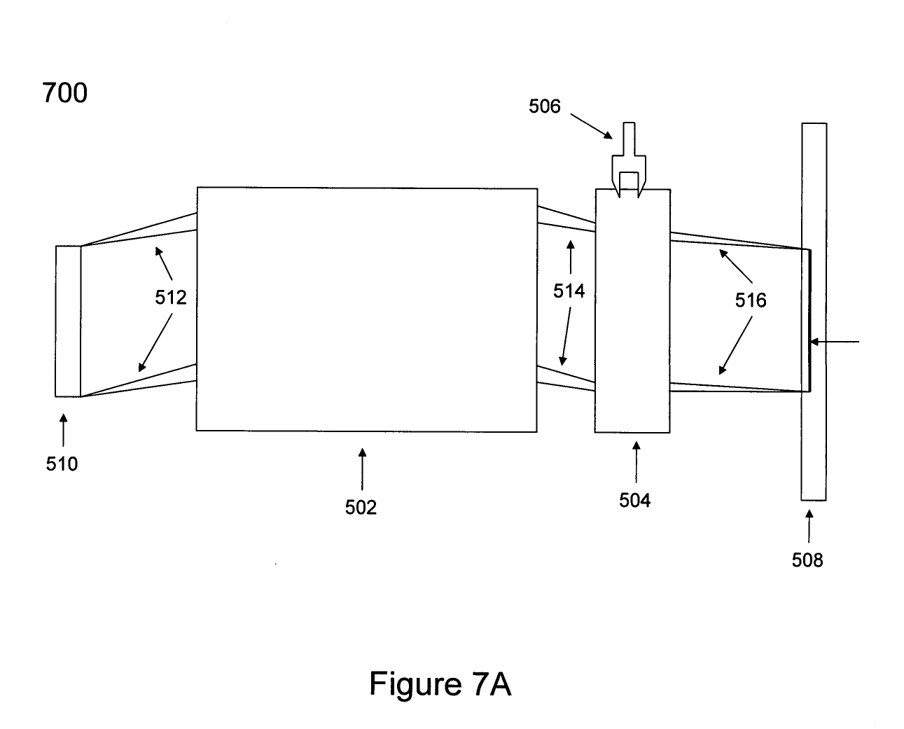

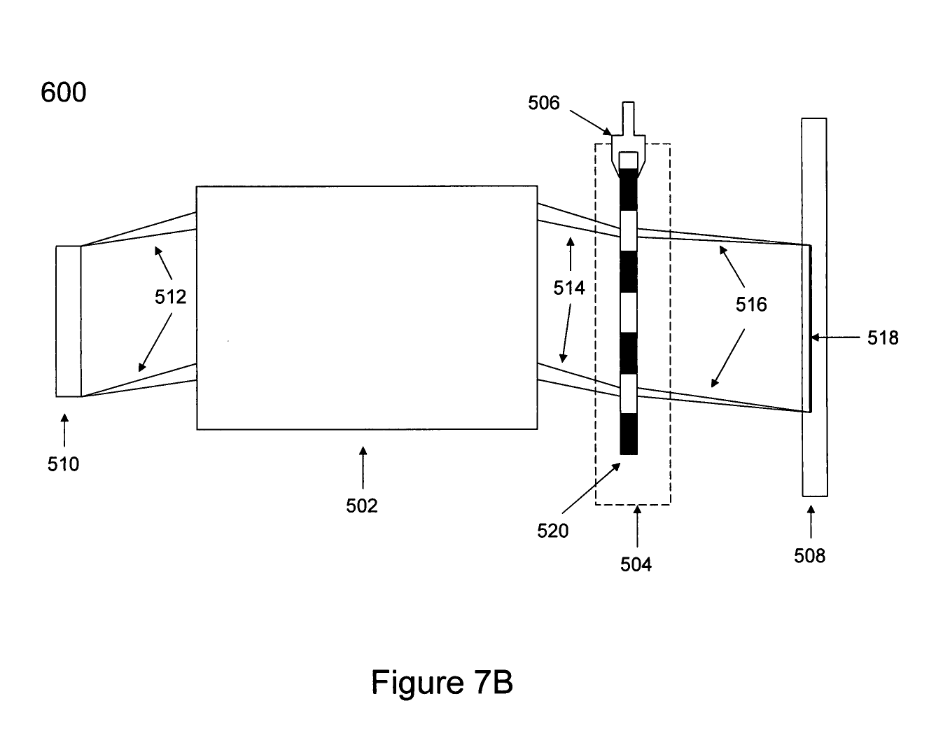

FIG. 7 is a schematic drawing illustrating an image capturing device that comprises refractive and diffractive elements, according to some embodiments of the present invention.

Embodiment 600 includes a refractive optical element 502, a diffractive optics element 504, a DOE manipulator 506, and an image capturing sensor 508. Diffractive optics element 504 is optionally diffractive optics element 106 as described in FIGS. 1, 2A, 2B, 3, 4A, 4B, 6A, and 6B; optionally diffractive optics element 504 optionally includes diffractive sub-element 400 as described in FIG. 5. DOE manipulator 506 is optionally DOE manipulator 114, as shown in FIGS. 1, 2A, 2B, 3, 4A, 4B, 6A, and 6B. Image capturing sensor 508 is optionally sensor 110, as shown in FIGS. 1, 2A, 2B, 3, 4A, 4B, 6A, and 6B.

Refractive optics element is optionally a lens setup, including a plurality of lenses, as typically used in refractive image capturing devices known in the art.

In FIG. 7, an object or scene 510 emits and/or reflects light waves 512. Light waves 512 impinge refractive optics element 502, and refract into refracted light waves 514. Refracted light waves 514 impinge diffractive optics element 504 that transmits diffracted light waves 516. Diffracted light waves 516 impinge sensor 508 and an image 518 of object or scene 510 is formed on a receiving surface of sensor 508. DOE manipulator 506 manipulates diffractive optics element 504, for example by moving diffractive optics element 504, in order to change at least one property of image 518, as described in previous figures. Optionally, the property is one of image size and image focus level, as described above.

Optionally, refractive optics element 502 is able to form image 518 on a surface of sensor 508, without any contribution by diffractive optics element 504. Optionally, refractive optics element 502 may also be manipulated, in order to control properties of image 518.

Optionally, diffractive optics element 504 is placed on an image or an object side of refractive optics element 502. Optionally, diffractive optics element 504 is incorporated within refractive optics element 502.

FIGS. 7A and 7B are schematic drawings illustrating an image capturing device that comprises refractive and diffractive elements, according to some embodiments of the present invention.

Embodiment 700 includes all the elements of embodiment 600 of FIG. 7S. In FIG. 7, diffractive optics element 504 includes a diffractive sub-element 520, characterized by zones of different groove densities, like sub-element 302 of FIGS. 4A and 4B. Optionally, DOE manipulator 506 moves diffractive sub-element 520 in a direction normal to the focal axis of the image capturing device, in order to control a size of image 508, as explained above and depicted in FIG. 7B. Optionally or alternatively, DOE manipulator 506 moves diffractive sub-element 520 along the focal axis of the image capturing device, in order to control a focus level of image 508.

Optionally, diffractive sub-element 520 is characterized by more than two zones of different groove densities. Optionally, diffractive sub-element 520 is configured for changing a size of image 508 is discrete steps, as explained above. Optionally, diffractive sub-element 520 is characterized by a plurality of zones of different groove densities, like sub-element 400 of FIG. 5. Optionally, diffractive sub-element 520 is configured for changing a size of image 508 gradually, as explained above.

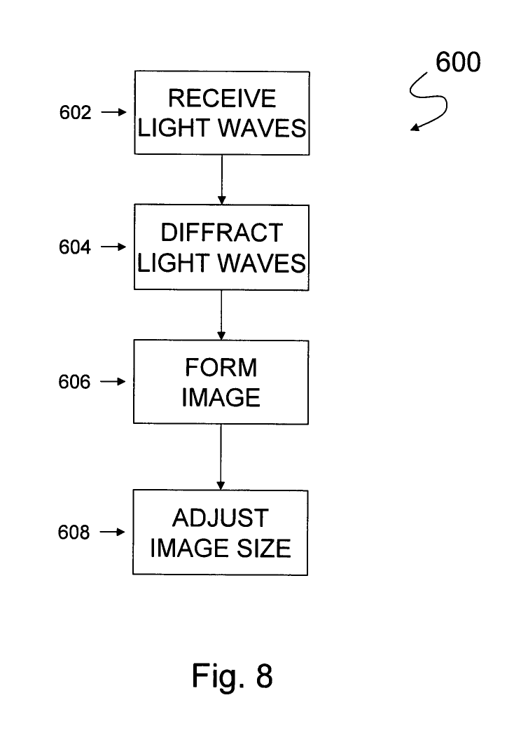

FIG. 8 is a flowchart of a method 600 for forming an image on a surface and changing image properties through diffraction, according to some embodiments of the present invention.

At 602, light waves emitted by and/or reflected from an object are received. At 604, the received light waves are diffracted, by a diffractive optics element. At 606, an image is formed, for example by converging the diffracted waves onto a surface. Optionally, the surface is the receiving surface of an image capturing sensor, placed close to the diffractive optics element. For example, the surface may be placed about 2 mm, 3 mm, 5 mm, 10 mm, 20 mm, 50 mm an intermediate distance, a higher distance, or a lower distance away from the diffractive optics element. At 608, at least a property of the image is adjusted, by manipulating the diffractive optics element. Optionally, the property is the size of the image. Optionally, the property is the focus of the image.

Optionally, the diffracting of 604 is effected by diffractive optics elements described above. Method 800 may be used for image capturing devices which use diffractive imaging, focusing, and/or zooming systems, as described above. Such image capturing devices are typically more limited in thickness than image capturing devices with imaging, focusing, and/or zooming systems which are based on a set of optical lenses. Furthermore, because of their limited thickness, at least some of these diffraction based image capturing devices can be configured to fit relatively thin mobiles phones. Optionally, method 600 may be used by image capturing devices based on hybrid refractive/diffractive optics, as described above.

It is expected that during the life of a patent maturing from this application many relevant applications will be developed and the scope of the term “adjusting an optical pathway” is intended to include all such new technologies a priori. Furthermore, many relevant types of diffractive optics elements—characterized by different numbers and types of sub-elements and configurations—will be developed, and the scope of the term “diffractive optics element” is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An apparatus for adjusting an optical pathway, comprising:
a diffractive optics element configured for diffracting a plurality of light waves passing in the optical pathway; and
a diffractive optics element (DOE) manipulator configured for manipulating said diffractive optics element, thereby changing the optical pathway.

2. The apparatus of claim 1, wherein said plurality of light waves includes white light.

3. The apparatus of claim 1, wherein said changing comprises changing said diffracting.

4. The apparatus of claim 1, further comprising an image capturing sensor having a receiving side, said diffractive optics element being configured for diffracting said plurality of light waves to form an image on said receiving side.

5. The apparatus of claim 4, further comprising a user interface configured for allowing a user to control said DOE manipulator thereby changing a magnification of said image.

6. The apparatus of claim 4, wherein said apparatus is incorporated within a member selected from a group consisting of: a mobile phone, a personal digital assistant (PDA), a laptop, and a digital camera.

7. The apparatus of claim 1, further comprising a refractive optical element, said optical pathway being manipulated according to said refractive optical element.

8. The apparatus of claim 7, wherein said refractive optical element is a lens setup of a refractive image capturing device.

9. The apparatus of claim 7, further comprising at least one refractive element for manipulating said plurality of light waves.

10. The apparatus of claim 1, further comprising a correcting element on an image side of said diffractive optics element, for correcting aberrations caused by diffraction.

11. The apparatus of claim 1, wherein said diffractive optics element comprises an odd number of diffractive sub-elements.

12. The apparatus of claim 11, wherein said diffractive optics element comprises:
a first diffractive sub-element;
a second diffractive sub-element; and
a third diffractive sub-element.

13. The apparatus of claim 12, wherein said first, second, and third diffractive sub-elements include diffractive gratings.

14. The apparatus of claim 12, wherein said first diffractive sub-element transmits light waves of a first order of diffraction; said second diffractive sub-element transmits light waves of a second order of diffraction; and said third diffractive sub-element transmits light waves of a third order of diffraction;
wherein said first order of diffraction is not less than said second order of diffraction, and said third order of diffraction is not less than said second order of diffraction.

15. The apparatus of claim 14, wherein said first order of diffraction, said second order of diffraction, and said third order of diffraction are integer numbers in a range between 1 and 2.

16. The apparatus of claim 12, wherein said second diffractive sub-element has alternating zones of at least two groove densities.

17. The apparatus of claim 16, wherein said first diffractive sub-element has a first groove density; said second diffractive sub-element has alternating zones of different groove densities; and third diffractive sub-element has a third groove density;
wherein said first groove density is not less than the lowest of said different groove densities of said second diffractive sub-element; and said third groove density is not less than the highest of said different groove densities of said second diffractive sub-elements.

18. The apparatus of claim 16, wherein said DOE manipulator moves said second diffractive sub-element relative to said first diffractive sub-element, such that light transmitted by said first diffractive sub-element impinges said second diffractive sub-element in zones of a selected groove density, thereby creating a zoom effect.

19. The apparatus of claim 18, wherein said DOE manipulator moves said second diffractive sub-element relative to said first diffractive sub-element in a direction normal to the focal axis.

20. The apparatus of claim 16, wherein said second diffractive sub-element has alternating zones of two groove densities.

21. The apparatus of claim 17, wherein said different groove densities comprise a higher groove density and a lower groove density;
wherein said first groove density is not less than said lower groove density, and said third groove density is not less than said higher groove density.

22. The apparatus of claim 16, wherein said second diffractive sub-element has alternating zones of three different groove densities.

23. The apparatus of claim 16, wherein said second diffractive sub-element has alternating zones of a plurality of groove densities.

24. The apparatus of claim 18, wherein said zoom effect is gradually changing.

25. The apparatus of claim 12, comprising an image capturing sensor having a receiving side, said diffractive optics element being configured for diffracting said plurality of light waves to form an image on said receiving side, wherein a distance between said first diffractive sub-element and said image capturing sensor is less than 8 mm.

26. A method for adjusting an optical pathway, comprising:
using a diffractive optics element for diffracting a plurality of light waves reflected from an object in the optical pathway;
manipulating said diffractive optics element, thereby adjusting the optical pathway; and
forming an image of said object on a surface by diffractive means alone.

27. The method of claim 26, wherein said surface is a receiving surface of an image capturing sensor, placed close to said diffractive optics element.

28. The method of claim 26, further comprising:
adjusting at least one property of said formed image by manipulating said diffractive optics element.

29. The method of claim 28, wherein said property is one of image size and image focus level.

30. The method of claim 26, further comprising correcting for at least some optical aberrations of said image, by using at least one of: said diffractive optics element, said image capturing sensor, and a correcting element.

31. The method of claim 26, wherein said diffracting comprises:
converging said light waves by a first diffractive element onto a second diffractive element;
diverging said light waves by a second diffractive element onto a third diffractive element; and
converging said light waves by a third diffractive element onto said surface.

32. The method of claim 28, wherein said manipulating comprises moving said second diffractive element, such that said light waves impinge said second diffractive element in zones of a specific groove density.

33. An optical device, comprising:
a diffractive optics element, configured for diffracting light waves from an object; and
a surface upon which an image of said object is formed;
wherein said diffractive optics element forms said image upon said surface by diffractive means alone.

34. The device of claim 33, wherein said surface is a receiving surface an image capturing sensor, and the device is an image capturing device.

35. The device of claim 33, further comprising at least one correcting element configured for correcting at least some optical aberrations of said image, caused by diffraction.

36. The device of claim 35, wherein said correcting element is a diffractive optics element.

37. The device of claim 33, further including a diffractive optics element (DOE) manipulator configured for manipulating said diffractive optics element;
wherein said manipulating of said diffractive optics element by said DOE manipulator causes a change in at least one property of said image.

38. The device of claim 37, wherein said property is one of focus level and zoom level.

39. The device of claim 34, wherein a length from an object side of said diffractive optics element to an object side of said surface is not more than 8 mm.

40. The device of claim 34, wherein said receiving said image capturing sensor is configured for reducing at least one optical aberration of said image caused by diffraction.

41. The device of claim 40, wherein at least one algorithm is programmed on an Image Signal Processor (ISP) chip connected to said image capturing sensor, said ISP chip reducing said at least one optical aberration according to said algorithm.

42. The device of claim 33, wherein said diffractive optics element is configured for reducing at least some optical aberrations of said image caused by diffraction.

43. The device of claim 33, wherein said light waves comprise white light.

44. The device of claim 37, further comprising a user interface configured for allowing a user to control said DOE manipulator.

45. The device of claim 33, wherein said device is incorporated within a member selected from a group consisting of: a mobile phone, a personal digital assistant (PDA), a laptop, and a digital camera.
